SEQUENCE LISTING (6 sequences)

SEQ ID NO: 1 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDAGREMLQIHMIGNSMRTDDFRIEGISNFESDVTLFG

SEQ ID NO: 2 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFESDVTLFG

SEQ ID NO: 3 - protein, 269 aa, Thermomyces lanuginosus
CVSQDLFNQFNLFAQYSAAAYCGKNNRAPAGTNITCTANACPEVEKADATVLYSFEDSGVGDVTGFLALDNTNKLIVLSFRGSRSIENWIGNLNFELIEINDICSGCRGHAGFTSSWRSVADTLRQKVEDAVREHPDYRVVFTGHSLGGALATVAGADLRGNKYDIDVFSYGAPRVGNRAFAEFLTVQTGGTLYRITSTNDIVPRLPPREFGYSHSSPEFWIKSGTLVPVRRCDIVKIEGIDATGGNNQPNIPSITAHLWYFGLIGTCL

SEQ ID NO: 4 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFETDVNLYG

SEQ ID NO: 5 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDSGKEMLQIHMIGNSMRTDDFRIEGISNFESDVNLYG

SEQ ID NO: 6 - protein, 544 aa, Geotrichum candidum
QAPTAVLNGNEVISGVLEGKVDTFKGIPFADPPVGDLRFKHPQPFTGSYQGLKANDFSSACMQLDPGNAFSLLDKVVGLGKILPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDTSASDNDTLACLRSKSSDVLHSAQNSYDLKDLFGLLPQFLGFGPRPDGNIIPDAAYELYRSGRYAKVPYITGNQEDEGTILAPVAINATTTPHVKKWLKYICSQASDASLDRVLSLYPGSWSEGSPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLQQWDMYTDAGKEMLQIHMIGNSMRTDDFRIEGISNFESDVTLFG

(19) United States
(12) Patent Application Publication
(10) Pub. No.: US 2024/0124805 A1
(43) Pub. Date: Apr. 18, 2024

(54) LIPASE WITH LOW MALODOR GENERATION

(71) Applicant: Novozymes A/S, Bagsvaerd (DK)

(72) Inventors: Iben Damager, Vaerloese (DK); Mary Ann Stringer, Søborg (DK); Kim Borch, Birkerød (DK)

(73) Assignee: Novozymes A/S, Bagsvaerd (DK)

(21) Appl. No.: 18/262,051

(22) PCT Filed: Jan. 27, 2022
(86) PCT No.: PCT/EP2022/051847

§ 371 Date: Jul. 19, 2023

(30) Foreign Application Priority Data
Jan. 28, 2021 (DK) 2021 00089

(51) Int. Cl. C11D 3/386

(52) U.S. Cl. CPC C11D 3/38627; C11D 2111/12

(57) ABSTRACT

The present invention concerns detergent compositions comprising a lipase with low malodor generation during lipid stain removal.

### REFERENCE TO A SEQUENCE LISTING

This application contains a Sequence Listing in computer readable form, which is incorporated herein by reference.

### FIELD OF THE INVENTION

The present invention concerns detergent compositions comprising a lipase with low malodor generation during lipid stain removal.

### BACKGROUND OF THE INVENTION

The ability of a detergent to remove stains from the surface of textiles is an obvious care—about for the customer and various surfactant ingredients play a role in that process. However, there is a desire to reduce the amount of detergents used in household care for a number of reasons. One reason is that some of the ingredients in detergents are derived from petrochemical resources and face scrutiny due to environmental concerns, most of all for not being sustainable because they are from a non-renewable source and are poorly biodegradable or even persistent in the environment. Another reason is that lowering the detergent concentration in the wash liquor may reduce production cost and will ultimately lead to less transportation of detergents and consequently less burden on the environment. This trend toward compaction of detergents and reduced in-wash concentration of surfactants requires the development of solutions to ensure continued performance of the detergents, including new enzymes and new use of enzymes.

Lipases are included in some detergents to improve fat removal. When lipases degrade fat, short-chain fatty acids (e.g., butyric acid and hexanoic acid) can be released, leading to malodor perception. The dosage of lipase is therefore often limited in laundry detergents by the highest acceptable level of malodors, though the malodors can partly be masked by including an ester-free perfume system to the detergent formulation. Lipase has highest activity under semidry conditions, which are present during drying. The challenge with lipase odor generation is largest under wash conditions with low detergent level, since more lipase will be left on the stain after wash.

WO 2016/050661 (Novozymes A/S) discloses lipase variants which develop a low level or reduced level of malodor as compared to the parent enzyme.

WO 2017/001673 (Novozymes A/S) relates to methods of reducing malodor during lipid stain removal. The problem with malodor generation remains to be solved as lipases currently available for use in detergents all liberate short chain fatty acid (e.g. butyric acid) during hydrolysis of lipid, said short chain fatty acids often having an unpleasant odor.

Bertolini et al (Eur. J. Biochem. 228, 863-869 (1995)) discloses Geotrichum candidum lipase I (GCL I). For unsaturated substrates having long fatty acyl chains (linoleic acid and alpha-linoleic acid) GCL I shows higher specific activity than GCL II, whereas GCL II showed higher specific activity against saturated substrates having short fatty acid chains.

SEQ ID NO: 2 is disclosed in Shimada et al: cDNA Molecular Cloning of Geotrichum candidum Liase, The Journal of Biochemistry, Volume 106, Issue 3, Sep. 1989, Pages 383-388, (world wide web: doi.org/10.1093/oxfordjournals.jbchem.a122862) and Swisss-Prot: P17573.

SEQ ID NO: 3 is disclosed in WO2018/001959.

SEQ ID NO:6 is disclosed in WO9401567 (Unilever)

The prior art does not disclose the use of GCL I in detergent compositions.

### SUMMARY OF THE INVENTION

The inventors of the present invention have surprisingly found that lipases with a preference for unsaturated substrates having long fatty acyl chains (e.g. linoleic acid and alpha-linoleic acid), such as Geotrichum candidum lipase I, can be used in detergent leading to less malodor generation compared with the lipases that liberate short chain fatty acid (e.g. butyric acid) during hydrolysis of lipid.

Further, petrochemically derived compounds present in detergents are not sustainable because they are derived from a non-renewable source and are poorly biodegradable or even persistent in the environment. The inventors of the present invention have surprisingly found that more sustainable detergent compositions, i.e. detergent compositions with an improved sustainability profile, can be achieved by reducing the detergent load by addition of GCL I while maintaining or even improving the wash performance of the detergent. In addition to being produced from a renewable agricultural source, and in contrast to many detergent ingredients, lipases are naturally found in the environment and readily biodegradable. The replacement of detergent ingredients with GCL I addresses the United Nations' Sustainable Development Goals, in particular Goal 12 “Responsible consumption and production”: replacing detergent ingredients with GCL I allows the detergent producer—and thus the end user—to move from a fossil feedstock to a renewable feedstock and reduce the volume of persistent chemicals emitted to the environment.

The inventors of the present invention have surprisingly found that GCL I have a very good performance on lipid removal in wash when the detergent is dosed at reduced levels. Accordingly, the present invention makes it possible to use GCL I in detergents with good benefit in terms of both lipid removal and low odor generation and allows at same time for a significant reduction of the in-wash detergent load.

### DEFINITIONS

As used herein, the articles “a” and “an” are understood to mean one or more of what is claimed or described.

AEP (active enzyme protein): Enzyme protein which has a catalytic activity. There is various way to determine AEP. For example, AEP can be calculated by dividing total activities by the enzyme's specific activity.

Corresponding to: The term “corresponding to” as used herein, refers to a way of determining the specific amino acid of a sequence wherein reference is made to a specific amino acid sequence. E.g. for the purposes of the present invention, when references are made to specific amino acid positions, the skilled person would be able to align another amino acid sequence to said amino acid sequence that reference has been made to, in order to determine which specific amino acid may be of interest in said another amino acid sequence.

For purposes of the present invention, the mature polypeptide disclosed in SEQ ID NO: 2 is used to determine the corresponding amino acid residue in another GCL I. The amino acid sequence of another GCL I is aligned with the mature polypeptide disclosed in SEQ ID NO: 2, and based on the alignment, the amino acid position number corresponding to any amino acid residue in the mature polypeptide disclosed in SEQ ID NO: 2 is determined using the Needleman-Wunsch algorithm (Needleman and Wunsch, 1970, l J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix.

The following nomenclature is used when identifying variations in a GCL I sequence compared to SEQ ID NO: 2: Amino acid of SEQ ID NO: 2, position, amino acid of compared GCL I. For example, when SEQ ID NO: 1 is aligned with SEQ ID NO: 2 it is noted that the GCL I of SEQ ID NO: 1 differs from the GCL I of SEQ ID NO: 2 in that it has alanine (A) in position 509 instead serine (S). The nomenclature for that variation will thus be S509A as the accepted IUPAC single letter or three letter amino acid abbreviation is employed.

Detergent adjunct ingredient: The detergent adjunct ingredient is different to the GCL I of this invention. The precise nature of these additional adjunct components, and levels of incorporation thereof, will depend on the physical form of the composition and the nature of the operation for which it is to be used. Suitable adjunct materials include, but are not limited to the components described below such as surfactants, builders, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, s, s, brighteners, suds suppressors, dyes, perfumes, structure elasticizing agents, fabric softeners, carriers, hydrotropes, builders and co-builders, fabric hueing agents, anti-foaming agents, dispersants, processing aids, solvents, and/or pigments.

Detergent composition: The term “detergent composition” refers to compositions that find use in the removal of undesired compounds from items to be cleaned, such as textiles. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, bar, or spray compositions) and includes, but is not limited to, detergent compositions (e.g., liquid and/or solid laundry detergents and fine fabric detergents; fabric fresheners; fabric softeners; laundry boosters; and textile and laundry pre-spotters/pre-treatment). In addition to containing the enzyme of the invention, the detergent formulation may contain one or more additional enzymes (such as proteases, amylases, lipases, cutinases, cellulases, endoglucanases, xyloglucanases, pectinases, pectin lyases, xanthanases, peroxidases, haloperoxygenases, catalases and mannanases, or any mixture thereof), and/or detergent adjunct ingredients such as surfactants, builders, chelators or chelating agents, bleach system or bleach components, polymers (as set forth herein), fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, bluing agents and fluorescent dyes, antioxidants, and solubilizers. The term “detergent composition” may be used interchangeably with the term “detergent”.

Detergent load is the amount of detergent used in a wash cycle.

Enzyme detergency benefit: The term “enzyme detergency benefit” is defined herein as the advantageous effect an enzyme may add to a detergent compared to the same detergent without the enzyme. Important detergency benefits which can be provided by enzymes are stain removal, such as lipid stains, with no or very little visible soils after washing and/or cleaning.

Fatty acid: A fatty acid is a carboxylic acid with an aliphatic tail (chain), which is either saturated or unsaturated. Most naturally occurring fatty acids have a chain of an even number of carbon atoms, from 4 to 28. Fatty acids are usually derived from triglycerides or phospholipids. When they are not attached to other molecules, they are known as “free” fatty acids. Examples of fatty acids include, but are not limited to, butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid) oleic acid, palmitoleic acid linoleic acid, linolenic acid, arachidonic acid, eicosapentaenoic acid, and docosahexaenoic acid. It is to be understood that in the context of this invention, a fatty acid and an acyl group of a lipid are equivalents. When the fatty acid is an acyl group of a lipid, the lipid can be a monoglyceride, diglyceride, triglyceride, phospholipid, sphingolipid, galactolipid, sterolester or wax ester. The acyl group may be saturated or unsaturated, and optionally functional groups (substituents) may be attached. Examples of acyl groups include, but are not limited to, the acyl forms of butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid), linoleic acid, linolenic acid, arachidonic acid, eicosapentaenoic acid, oleic acid, palmitoleic acid, and docosahexaenoic acid

Fragment: The term “fragment” means a polypeptide having one or more (e.g., several) amino acids absent from the amino and/or carboxyl terminus of a mature polypeptide or domain; wherein the fragment has GCL I activity.

Fungal: In the context of the present invention the term “fungal” in relation to polypeptide (such as an enzyme, e.g. a lipase) refers to a polypeptide encoded by and thus directly derivable 20 from the genome of a fungus, where such fungus has not been genetically modified to encode said polypeptide, e.g. by introducing the encoding sequence in the genome by recombinant DNA technology. In the context of the present invention, the term “fungal GCL I” or “polypeptide having GCL I activity obtained from a fungal source” thus refers to a GCL I encoded by and thus directly derivable from the genome of a fungal species, where the fungal species has not been subjected to a genetic modification introducing recombinant DNA encoding said GCL I. Thus, the nucleotide sequence encoding the fungal polypeptide having GCL I activity is a sequence naturally in the genetic background of a fungal species. The fungal polypeptide having GCL I activity encoding by such sequence may also be referred to a wildtype GCL I (or parent GCL I). In a further aspect, the invention provides polypeptides having GCL I activity, wherein said polypeptides are substantially homologous to a fungal GCL I. In the context of the present invention, the term “substantially homologous” denotes a polypeptide having GCL I activity which is at least 80%, preferably at least 85%, more preferably at least 90%, more preferably at least 95%, even more preferably at least 96%, 97%, 98%, and most preferably at least 99% identical to the amino acid sequence of a selected fungal GCL I. The polypeptides being substantially homologous to a fungal GCL I may be included in the detergent of the present invention and/or be used in the methods of the present invention.

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Improved wash performance: The term “improved wash performance” is defined herein as an enzyme displaying an increased wash performance in a detergent composition relative to the wash performance of same detergent composition without the enzyme e.g. by increased stain removal or improved bleaching. The term “improved wash performance” includes wash performance in laundry.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide of the invention. The fermentation broth from that host cell will comprise the isolated polypeptide.

Laundering: The term “laundering” relates to both household laundering and industrial laundering and means the process of treating textiles with a solution containing a detergent composition and optionally one or more enzymes. The laundering process can for example be carried out using e.g. a household or an industrial washing machine or can be carried out by hand.

Lipase: The terms “lipase”, “lipase enzyme”, “lipolytic enzyme”, “lipid esterase”, “lipolytic polypeptide”, and “lipolytic protein” refers to an enzyme in class EC3.1.1 as defined by Enzyme Nomenclature. It may have lipase activity (triacylglycerol lipase, EC3.1.1.3), cutinase activity (EC3.1.1.74), sterol esterase activity (EC3.1.1.13) and/or wax-ester hydrolase activity (EC3.1.1.50). In this context a “lipase substrate” or a “lipid” is any substrate which can be hydrolyzed by a lipase. GCL I is encompassed by the term lipase.

Malodor: The term “malodor” means an odor which is not desired on clean items. Malodor can be quantified by SPME-GC as released butyric acid or assessed by sensory panel scoring. Unless otherwise specified the term malodour may be used interchangeably with the term odor.

Mature polypeptide: The term “mature polypeptide” means a polypeptide in its final form following translation and any post-translational modifications, such as N-terminal processing,

C-terminal truncation, glycosylation, phosphorylation, etc.

Rhamnolipid: Rhamnolipid (RL) is a glycolipid that may be used as a biodegradable surfactant. RL may be in the form of mono-rhamnolipid or di-rhamnolipid, which consist of one or two rhamnose groups respectively, wherein the length of the chain may vary: m,n being 4 to 8.

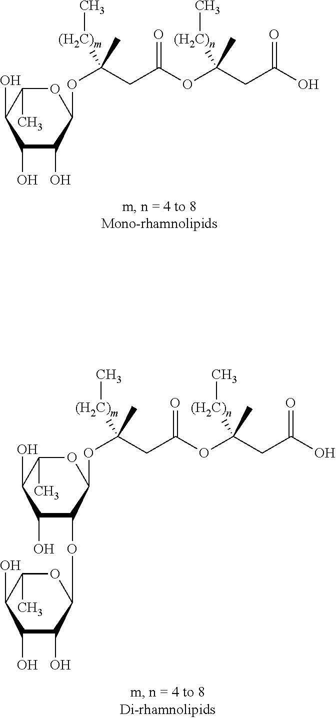

(Appl Microbiol Biotechnol (2005) 68: 718-725).

In the context of the present invention the term “rhamnolipid” includes mono-rhamnolipid or di-rhamnolipid, mixtures thereof and varying chain length as well as salts of rhamnolipid.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the —nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EM-BOSS: The European Molecular Biology Open Software Suite, Rice et al., 2000, supra), prefer-ably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment−Total Number of Gaps in Alignment).

Sophorolipid: In the context of the present application the term “sophorolipid” include sophorolipid in the lactone form and the corresponding acidic form as well as mixtures thereof. Further “sophorolipid” also includes salts of sophorolipid.

Substantially the same: The term “substantially same” in the present invention is within the reasonable understanding of those skilled in the art, and may mean that the level of lipid removal of different detergent compositions is similar or no obvious difference, for example, the difference in the level of lipid removal is within e.g. 1%, 2% or 3% depending on the experimental errors.

Sustainability: Sustainability and sustainable means use of renewable resources that cause little or no damage to the environment and are biodegradable.

Sustainability profile: In the context of the present invention the term sustainability profile is used for comparing the sustainability of ingredients (e.g. in a detergent composition) where one or more ingredients can replace other less sustainable ingredients while maintaining the performance of the system (e.g. the performance of a detergent composition during wash of an item).

TEP: Total Enzyme Protein is measured by amino acid analyses.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and toweling. The textile may be cellulose based such as natural cellulosics, includ-ing cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well. In the context of the present invention, the term “textile” also covers fabrics. In the context of the present invention, the term “textile” is used interchangeably with fabric and cloth.

Variant: The term “variant” means a polypeptide having same activity as the parent enzyme comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and detergent components optionally including one or more enzymes.

Wash performance: The term “wash performance” is used as detergent composition's, enzyme's or polymer's capability to remove stains present on the object to be cleaned or maintain color and whiteness of textile during wash. The improvement in the wash performance may be quantified by lipid removal or odor generation as described in the Experimental section.

Weight percentage: is abbreviated w/w %, wt % or w %. The abbreviations are used interchangeably.

### Sequence Overview

SEQ ID NO: 1 is a lipase from Geotrichum candidum

SEQ ID NO: 2 is a lipase from Geotrichum candidum

SEQ ID NO: 3 is a lipase from Thermomyces lanuginosus

SEQ ID NO: 4 is a lipase from Geotrichum candidum

SEQ ID NO: 5 is a lipase from Geotrichum candidum

SEQ ID NO: 6 is a lipase from Geotrichum candidum

### DETAILED DESCRIPTION OF THE INVENTION

The inventors of the present invention have surprisingly found that an GCL I have a very good performance on lipid removal from textile in wash with only low malodor generation. Further, it has been established that the GCL I have a good enzyme detergency benefit on lipid stain removal even when the detergent is dosed at reduced detergent level. Consequently, the invention makes it possible to use the GCL I of the present invention with good benefit in terms of lipid removal and no or low malodor generation and can at same time reduce the detergent load significantly.

Accordingly, the present invention relates to the use of a lipase a stain on textile in a wash liquor, wherein the wash liquor comprises about 0.2 to 5 g/L of a detergent, and optionally one or more additional enzymes.

The wash liquor may have a temperature in the range of 5° C. to 95° C., or in the range of 10° C. to 80° C., in the range of 10° C. to 70° C., in the range of 10° C. to 60° C., in the range of 10° C. to 50° C., in the range of 15° C. to 40° C. or in the range of 20° C. to 40° C.

In one embodiment of the invention, the method for laundering an item further comprises draining of the wash liquor or part of the wash liquor after completion of a wash cycle. The wash liquor can then be re-used in a subsequent wash cycle or in a subsequent rinse cycle. The item may be exposed to the wash liquor during a first and optionally a second or a third wash cycle. In one embodiment the item is rinsed after being exposed to the wash liquor. The item can be rinsed with water or with water comprising a conditioner.

A GCL I suitable for use as described in the present application is preferably an GCL I derived from Geotrichum candidum selected from SEQ ID NO: 1, SEQ ID NO: 2, SEQ ID NO: 4, SEQ ID NO: 5 or SEQ ID NO: 6.

In an embodiment, the GCL I comprises the amino acid sequence of SEQ ID NO: 1 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 1.

In an embodiment the GCL I comprises one or more, such as 2, 3, 4 or 5, variations selected from the group consisting of S509A, K511R, S538T, T541N and F543 when aligned with SEQ ID NO: 2 applying the settings outlined in the paragraph “Corresponding to”.

In an embodiment the GCL I comprises the variations S509A and K511R when aligned with SEQ ID NO: 2 applying the settings outlined in the paragraph “Corresponding to”.

In an embodiment the GCL I comprises the variations S538T, T541N and F543Y when aligned with SEQ ID NO: 2 applying the settings outlined in the paragraph “Corresponding to”.

In an embodiment the GCL I comprises the variations T541N and F543Y when aligned with SEQ ID NO: 2 applying the settings outlined in the paragraph “Corresponding to”.

In an embodiment the GCL I comprises the variations 170F, 183L, A278T, G281S, E284D, E381Q, A4025, K501Q, S509A, wherein numbering is according to SEQ ID NO: 2 applying the settings outlined in the paragraph “Corresponding to”

In an embodiment, the GCL I of SEQ ID NO: 1 comprises a substitution, deletion, and/or insertion at one or more (e.g., several) positions. In an embodiment, the number of amino acid substitutions, deletions and/or insertions introduced into the polypeptide SEQ ID NO: 1 is not more than 10, e.g., 1, 2, 3, 4, 5, 6, 7, 8 or 9. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids 30 (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for enzyme activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labelling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide of the present invention. A fusion polypeptide is produced by fusing a polynucleotide encoding another polypeptide to a polynucleotide of the present invention. Techniques for producing fusion polypeptides are known in the art and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

A fusion polypeptide can further comprise a cleavage site between the two polypeptides.

Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 10 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

General methods of PCR, cloning, ligation nucleotides etc. are well-known to a person skilled in the art and may for example be found in in “Molecular cloning: A laboratory manual”, Sambrook et al. (1989), Cold Spring Harbor lab., Cold Spring Harbor, NY; Ausubel, F. M. et al. (eds.); “Current protocols in Molecular Biology”, John Wiley and Sons, (1995); Harwood, C. R., and Cutting, S. M. (eds.); “DNA Cloning: A Practical Approach, Volumes I and II”, D.N. Glover ed. (1985); “Oligonucleotide Synthesis”, M.J. Gait ed. (1984); “Nucleic Acid Hybridization”, B. D. Hames & S. J. Higgins eds (1985); “A Practical Guide To Molecular Cloning”, B. Perbal, (1984).

The concentration of the GCL I (AEP) in the wash liquor is typically in the range of 0.05-20 ppm (mg/L) enzyme protein, such as in the range of 0.1-15 ppm, in the range of 0.5-15 ppm, in the range of 1-15 ppm, in the range of 1-10 ppm, in the range of 2-10 ppm.

The GCL I (as formulated product) may be present in the detergent in a concentration from 0.2-10 wt %, such as in the range of 0.5-5 wt %, such as in the range of 0.5-3 wt %, such as in the range of 0.5-2.5 wt %, or in the range of 0.5-2 wt %, or even in the range of 0.5-1 wt %.

The GCL I of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

### Detergent Compositions

In one embodiment, the invention is directed to detergent compositions comprising a GCL I in combination with one or more additional cleaning composition components. In one embodiment, the detergent composition comprises a polypeptide having GCL I activity with an amino acid sequence having at least 60% identity, such as 70%, 80%, 90%, 95%, 96%, 97%, 98%, 99% or even 100% identity to the amino acid sequence set forth in SEQ ID NO: 1. In one embodiment the detergent composition is in solid form. In another embodiment, the detergent composition is in a liquid or gel form. In another embodiment a bar form. In one embodiment the detergent may be wrapped in water soluble PVOH film. The choice of additional components is within the skill of the artisan and includes conventional ingredients, including the exemplary non-limiting components set forth below.

### Liquid Detergent Composition

The liquid detergent composition may comprise a microcapsule, and thus form part of any detergent composition in any form, such as liquid and powder detergents, and soap and detergent bars.

In one embodiment, the invention is directed to liquid detergent compositions comprising a microcapsule, as described above, in combination with one or more additional cleaning composition components.

The microcapsule, as described above, may be added to the liquid detergent composition in an amount corresponding to from 0.0001% to 5% (w/w) active enzyme protein (AEP); preferably from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

The liquid detergent composition has a physical form, which is not solid (or gas). It may be a pourable liquid, a paste, a pourable gel or a non-pourable gel. It may be either isotropic or structured, preferably isotropic. It may be a formulation useful for washing in automatic washing machines or for hand washing. It may also be a personal care product, such as a shampoo, toothpaste, or a hand soap.

The liquid detergent composition may be aqueous, typically containing at least 20% by weight and up to 95% water, such as up to 70% water, up to 50% water, up to 40% water, up to 30% water, or up to 20% water. Other types of liquids, including without limitation, alkanols, amines, diols, ethers and polyols may be included in an aqueous liquid detergent. An aqueous liquid detergent may contain from 0-30% organic solvent. A liquid detergent may even be non-aqueous, wherein the water content is below 10%, preferably below 5%.

Detergent ingredients can be separated physically from each other by compartments in water dissolvable pouches. Thereby negative storage interaction between components can be avoided. Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry. A detergent unit dose product is the packaging (e.g., in a pouch made from a water-soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, maltodextrin, polymethacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend composition comprising hydrolytically degradable and water-soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (see e.g., US 2009/0011970).

### Detergent Ingredients

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

Any detergent components known in the art for use in detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in detergents may be utilized. The choice of such ingredients is well within the skill of the artisan and includes conventional ingredients, including the exemplary non-limiting components set forth below.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant and at least one non-ionic surfactant, the weight ratio of anionic to nonionic surfactant may be from 20:1 to 1:20. In one embodiment the amount of anionic surfactant is higher than the amount of non-ionic surfactant e.g. the weight ratio of anionic to non-ionic surfactant may be from 10:1 to 1.1:1 or from 5:1 to 1.5:1. The amount of anionic to non-ionic surfactant may also be equal and the weight ratios 1:1. In one embodiment the amount of non-ionic surfactant is higher than the amount of anionic surfactant and the weight ratio may be 1:10 to 1:1.1. Preferably the weight ratio of anionic to non-ionic surfactant is from 10:1 to 1:10, such as from 5:1 to 1:5, or from 5:1 to 1:1.2. Preferably, the weight fraction of non-ionic surfactant to anionic surfactant is from 0 to 0.5 or 0 to 0.2 thus non-ionic surfactant can be present or absent if the weight fraction is 0, but if non-ionic surfactant is present, then the weight fraction of the nonionic surfactant is preferably at most 50% or at most 20% of the total weight of anionic surfactant and non-ionic surfactant. Light duty detergent usually comprises more nonionic than anionic surfactant and there the fraction of non-ionic surfactant to anionic surfactant is preferably from 0.5 to 0.9. The total weight of surfactant(s) is typically present at a level of from about 0.1% to about 60% by weight, such as about 1% to about 40%, or about 3% to about 20%, or about 3% to about 10%. The surfactant(s) is chosen based on the desired cleaning application, and may include any conventional surfactant(s) known in the art. When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); in particular, linear alkylbenzenesulfonates (LAS), isomers of LAS such as branched alkylbenzenesulfonates (BABS) and phenylalkanesulfonates; olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate (SLS); alcohol ethersulfates (AES or AEOS or FES, also known as alcohol ethoxysulfates or fatty alcohol ether sulfates); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Anionic surfactants may be added as acids, as salts or as ethanolamine derivatives.

When included therein the detergent will usually contain from about 0.1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01 to about 10% by weight of a semipolar surfactant. Non-limiting examples of semipolar surfactants include amine oxides (AO) such as alkyldimethylamine oxides, in particular N-(coco alkyl)-N,N-dimethylamine oxide and N-(tallow-alkyl)-N,N-bis(2-hydroxyethyl)amine oxide, and combinations thereof.

When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

Additional bio-based surfactants may be used e.g. wherein the surfactant is a sugar-based non-ionic surfactant which may be a hexyl-β-D-maltopyranoside, thiomaltopyranoside or a cyclic-maltopyranoside, such as described in EP2516606 B1. Other biosurfactants may include rhamnolipids and sophorolipids.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however, the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include or copolymers thereof, such as poly(acrylic acid) (PAA) or copoly(acrylic acid/maleic acid) (PAA/PMA).

According to the present invention, these components can be included in lower levels than in currently available detergent compositions. Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diyIbis(phosphonic acid (HEDP),ethylenediaminetetramethylenetetrakis(phosphonic acid) (EDTMPA),diethylenetriaminepentamethylenepentakis(phosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854 and U.S. Pat. No. 5,977,053.

### Polymers and Dispersants

Generally, detergent compositions may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide anti-redeposition, fiber protection, soil release, dye transfer inhibition, grease cleaning and/or anti-foaming properties. Some polymers may have more than one of the above-mentioned properties and/or more than one of the below-mentioned motifs. Exemplary polymers include poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include polyethylene oxide and polypropylene oxide (PEO-PPO), diquaternium ethoxy sulfate, styrene/acrylic copolymer and perfume capsules Other exemplary polymers are disclosed in, e.g., WO 2006/130575. Salts of the above-mentioned polymers are also contemplated.

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Tinopal CBS-X is a 4.4′-bis-(sulfostyryl)-biphenyl disodium salt also known as Disodium Distyrylbiphenyl Disulfonate.Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore, random graft co-polymers are suitable soil release polymers. Suitable graft co-polymers are described in more detail in WO 2007/138054, WO 2006/108856 and WO 2006/113314 (hereby incorporated by reference).

### Anti-redeposition Agents

The detergent compositions of the present invention may also include one or more anti-redeposition agents such as carboxymethylcellulose (CMC), polyvinyl alcohol (PVA), polyoxyethylene and/or polyethyleneglycol (PEG), homopolymers of acrylic acid, copolymers of acrylic acid and maleic acid. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Additional Enzymes

The detergent additive as well as the detergent composition may comprise one or more [additional] enzymes such as a protease, a lipase, a cutinase, a cellulase, an amylase, carbohydrase, DNase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

The term “cellulase” means one or more (e.g., several) enzymes that hydrolyze a cellulosic material. The two terms polypeptide having cellulase activity and cellulase are used interchangeably. Cellulases may be selected from the group consisting of cellulases belonging to GHS, GH44, GH45, EC 3.2.1.4, EC 3.2.1.21, EC 3.2.1.91 and EC 3.2.1.172. Such enzymes include endoglucanase(s) (e.g. EC 3.2.1.4), cellobiohydrolase(s), beta-glucosidase(s), or combinations thereof.

Suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

### DNases (Deoxyribonuclease)

The term “DNase” means a polypeptide with DNase activity that catalyzes the hydrolytic cleavage of phosphodiester linkages in the DNA backbone, thus degrading DNA.

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN', subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™, Maxacal™, Maxapem®, Purafect® Ox, Purafect® OxP, Puramax®, FN2™, FN3™, FN4^{ex}™, Excellase®, Excellenz™ P1000, Excellenz™ P1250, Eraser™, Preferenz® P100, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel A G), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase 100T/L, Lipex 100T/L, Lipex 105T, Lipex Evity 100L, Lipex Evity 200L (all Novozymes A/S), Preferenz® L 100 (DuPont).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WP10/100028).

### Amylases

Suitable amylases include an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ Amplify; Amplify Prime; (from Novozymes A/S), and Rapidase™, Purastar™/Effectenz™, Powerase, Preferenz S1000, Preferenz S100 and Preferenz S110 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes A/S).

A suitable peroxidase is preferably a peroxidase enzyme comprised by the enzyme classification EC 1.11.1.7, as set out by the Nomenclature Committee of the International Union of

Biochemistry and Molecular Biology (IUBMB), or any fragment derived therefrom, exhibiting peroxidase activity.

Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions. The haloperoxidase may be a chloroperoxidase. Preferably, the haloperoxidase is a vanadium haloperoxidase, i.e., a vanadate—containing haloperoxidase. In a preferred method the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

The haloperoxidase may be derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hattlebii as described in WO 01/79459, Dendtyphiella saline as described in WO 01/79458, Phaeotrichoconis crotalarie as described in WO 01/79461, or Geniculosporium sp. as described in WO 01/79460.

Suitable oxidases include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), ora bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

### Licheninases

Licheninases (or lichenases) (e.g. EC 3.2.1.73) hydrolyse (1,4)-beta-D-glucosidic linkages in beta-D-glucans containing (1,3)- and (1,4)-bonds and can act on lichenin and cereal beta-D-glucans, but not on beta-D-glucans containing only 1,3- or 1,4-bonds.

### Pectate Lyases

Pectate lyases catalyze the cleavage of α-1,4-D-galacturonan (i.e., homogalacturonan or polygalacturonic acid) by an eliminative pathway leaving a double bond between C4 and C5 at the +1 subsite and a reducing sugar at the −1 subsite. Pectate lyases may also have pectin lyase activity.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Laundry Soap Bars

The GCL I of the invention may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄₊ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as, but not limited to, mixers, plodders, e.g. a two-stage vacuum plodder, extruders, cutters, logo- stampers, cooling tunnels and wrappers. The invention is not limited to preparing the laundry soap bars by any single method. The premix of the invention may be added to the soap at different stages of the process. For example, the premix containing a soap, GCL I, optionally one or more additional enzymes, a protease inhibitor, and a salt of a monovalent cation and an organic anion may be prepared, and the mixture is then plodded. The GCL I and optional additional enzymes may be added at the same time as the protease inhibitor for example in liquid form. Besides the mixing step and the plodding step, the process may further comprise the steps of milling, extruding, cutting, stamping, cooling and/or wrapping.

### EMBODIMENTS OF THE INVENTION

The invention is further defined in the following embodiments:

E(1) A detergent composition comprising a lipase, characterized in that the ratio between lipase activity on unsaturated long fatty acyl chains, e.g. oleic acid, to saturated short acyl chain; e.g. butyrate or valerate, is 4 or higher, such as 6, 8 or 10, and at least one surfactant.

E(2) A detergent composition comprising a Geotrichum candidum lipase I (GCL I) and at least one surfactant and optionally one or more enzymes.

E(3) The detergent composition according to any of the previous embodiments, wherein the lipase has at least 70% identity to SEQ ID NO: 1, such as at least 80%, 85%, 90%, 91%, 92%, 93%, 94%, 95%, 96%, 97%, 98%, 99%, 99.1%, 99.2%, 99.3%, 99.4%, 99.5%, 99.6%, 99.7%,99.8%, or 99.9% identity to SEQ ID NO: 1.

E(4) The detergent composition according to any of E(1) and E(2), wherein the lipase has 100% identity to SEQ ID NO: 1, SEQ ID NO: 2 SEQ ID NO: 4, SEQ ID NO: 5 or SEQ ID NO: 6.

E(5) The detergent composition according to any of E(1) to E(3), wherein the lipase comprises 1 to 10 amino acid substitutions, preferably conservative amino acid substitutions, compared to SEQ ID NO: 1.

E(6) The detergent composition according to any of E(1) to E(5), wherein the amount of GCL I calculated as active enzyme protein (AEP) in the detergent composition is from 0.1 mg AEP/g detergent composition to 50 mg AEP/g detergent composition, such as 0.1 mg AEP/g detergent composition to 40 mg AEP/g detergent composition, such as 0.1 mg AEP/g detergent composition to 30 mg AEP/g detergent composition, such as 0.1 mg AEP/g detergent composition to 20 mg AEP/g detergent composition, such as 0.1 mg AEP/g detergent composition to 10 mg AEP/g detergent composition, such as 0.2 mg AEP/g detergent composition to 50 mg AEP/g detergent composition, such as 0.2 mg AEP/g detergent composition to 40 mg AEP/g detergent composition, such as 0.2 mg AEP/g detergent composition to 30 mg AEP/g detergent composition, such as 0.2 mg AEP/g detergent composition to 20 mg AEP/g detergent composition, such as 0.2 mg AEP/g detergent composition to 10 mg AEP/g detergent composition.

E(7) A method for removal of lipid in a textile during a wash cycle comprising contacting the textile with a detergent composition comprising a Geotrichum candidum lipase I (GCL I) and at least one surfactant and optionally one or more enzymes.

E(8) The method according to E(7), wherein the lipase has at least 70%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%,99.8%, or 99.9% identity to SEQ ID NO: 1.

E(9) The method according to any of E(7) or E(8), wherein the lipase has 100% identity to SEQ ID NO: 1, SEQ ID NO: 2 SEQ ID NO: 4 SEQ ID NO: 5 or SEQ ID NO: 6.

E(10) A washing method for textile comprising:
a. exposing a textile to a wash liquor
   i. comprising a Geotrichum candidum lipase I (GCL I), or
   ii. comprising a detergent composition according to any of embodiments (E1) to E(6);
b. completing at least one wash cycle, and
c. optionally rinsing the textile.

E(11) The washing method according to E(10), wherein the temperature of the wash liquor is in the range of 5° C. to 90° C., or in the range of 10° C. to 80° C., or in the range of 10° C. to 70° C., or in the range of 10° C. to 60° C., or in the range of 10° C. to 50° C., or in the range of 15° C. to 40° C., or in the range of 20° C. to 30° C.

E(12). The washing method according to any of E(10) or E(11), wherein the odor from the wet and/or dry textile is lower compared to the odor generation from a lipase having SEQ ID NO: 3 when a substantially same level of lipid removal is obtained, wherein the odor generation is measured by a sensorial assay or butyric acid release as determined by Solid Phase Micro Extraction Gas Chromatograph measurements.

E(13) The washing method according to E(12), wherein the odor generation is at least 2 times lower, such as 3 times lower, compared to the odor generation from a lipase having SEQ ID NO: 3 when a substantially same level of lipid removal is obtained by e.g. the Terg-O-tometer (TOM) wash assay, wherein the odor generation is measured by a sensorial assay or butyric acid release as determined by Solid Phase Micro Extraction Gas Chromatograph measurements.

E(14) The detergent composition, method and washing method according to any of the previous embodiments further comprising one or more enzymes selected from the group consisting of proteases, amylases, deoxyribonucleases, xyloglucanases, pectinases, pectin lyases, xanthanases, peroxidases, haloperoxygenases, cellulases, licheninase, lipases, cutinases, catalases, oxidase, arabinose, galactanase and mannanases.

E(15) Use of the detergent composition according to any of E(1) to E(6) for the improvement of the sustainability profile of a detergent composition by reducing the detergent load by addition of GCL I to the detergent composition while maintaining substantially the same wash performance of the detergent composition.

E(16) Use of the detergent composition according to any of E(1) to E(6) for removal of lipid stain on textile in a wash liquor, wherein the wash liquor comprises from about 0.2 g detergent composition/L wash liquor to about 5 g detergent composition/L wash liquor, such as 0.3 to 4.5 g detergent composition/L wash liquor, 0.4 to 4 g detergent composition/L wash liquor or 0.5 to 3.5 g detergent composition/L wash liquor.

E(17) The method according to any of E(7) to E(13) wherein the wash liquor comprises from about 0.2 g detergent composition/L wash liquor to about 5 g detergent composition/L wash liquor, such as 0.3 to 4.5 g detergent composition/L wash liquor, 0.4 to 4 g detergent composition/L wash liquor or 0.5 to 3.5 g detergent composition/L wash liquor.

E(18) The detergent composition, method or use according to any of the E(1) to E(17), wherein the GCL I comprises one or more, such as 2, 3, 4, 5, 6, 7, 8 or 9 variations selected from the group consisting of I70F, I83L, A278T, G281S, E284D, E381Q, A4025, K501Q, S509A, K511R, S538T, T541N and F543Y wherein numbering is according to SEQ ID NO: 2 applying the settings outlined in the paragraph “Corresponding to”.

E(19) The detergent composition, method or use according to any of the E(1) to E(18), wherein the GCL I comprises the variations S509A and K511R wherein numbering is according to SEQ ID NO: 2 applying the settings outlined in the paragraph “Corresponding to”.

E(20) The detergent composition, method or use according to any of the E(1) to E(18), wherein the GCL I comprises the variations S538T, T541N and F543Y wherein numbering is according to SEQ ID NO: 2 applying the settings outlined in the paragraph “Corresponding to”.

E(21) The detergent composition, method or use according to any of the E(1) to E(18), wherein the GCL I comprises the variations T541N and F543Y wherein numbering is according to SEQ ID NO: 2 applying the settings outlined in the paragraph “Corresponding to”.

E(22) The detergent composition, method or use according to any of the E(1) to E(18), wherein the GCL I comprises the variations I70F, I83L, A278T, G281S, E284D, E381Q, A4025, K501Q, S509A, wherein numbering is according to SEQ ID NO: 2 applying the settings outlined in the paragraph “Corresponding to”.

E(23) The detergent composition according to any of E(1) to E(6) further comprising 0.05-20 wt % rhamnolipid, such as 1-15 wt % rhamnolipid, such as 2-10 wt % rhamnolipid, such as 3-9 wt % rhamnolipid, such as 4-8 wt % rhamnolipid.

E(24) Use of the detergent composition according to E(23) for prevention of redeposition of soil during laundering.

E(25) A method for prevention of redeposition of soil during washing textile, said method comprising:
a. exposing a textile to a wash liquor comprising the detergent composition according to E(23)
b. completing at least one wash cycle, and
c. optionally rinsing the textile.

### Experimental

### Detergents

### Commercial Detergent Used in the Experiments

The commercial detergent Ecover non-bio was used in the laundry experiments.

TABLE 1
Components in Ecover non-bio detergent
Ecover non-bio

Aqua
Fatty alcohol ethoxylate C12-18
Sodium lauryl sulfate
Potassium oleate
Alcohol denatured
Sodium citrate
Trisodium Ethylenediamine Disuccinate
Polypropylene terephthalate
Perfume
Citric acid
Glycerin
Limonene
Linalool

### Model Detergents Used in the Experiments

The following model detergents have been used in the laundry experiments:

TABLE 2
Model 1 detergent

| Compound | Content of compound (% w/w) |
|---|---|
| Sodium lauryl sulfate (SLS) | 5.0 |
| Alkyl polyglucoside (APG) | 4.0 |
| Coco soap | 2.0 |
| N,N-bis(carboxymethyl)glutamic | 0.75 |
| acid (GLDA) | |
| Glycerol | 2.5 |
| EtOH | 2.5 |
| H₂O, ion exchanged | 83.25 |

TABLE 3
Model 2 detergent

| Compound | Content of compound (% w/w) |
|---|---|
| Sophorolipids | 4.9 |
| Coco soap | 5.6 |
| N,N-bis(carboxymethyl)glutamic | 1.1 |
| acid (GLDA) | |
| Glycerol | 15 |
| EtOH | 6 |
| KOH | 1.4 |
| H₂O, ion exchanged | 66 |

### pNP Assay for Determination of Lipase Activity

### Principle

The substrate pNP-substrate is hydrolyzed by the lipolytic enzyme under standard conditions. pNP-valerate is used as an example of a saturated short chain fatty acid. Valeric acid as the acyl group may be replaced by a long chain fatty acid such as oleic acid.

Hydrolysis of the pNP-substrate results in a yellow solution, the absorbance of the solution measured at 405 nm is a function of the activity of the lipolytic enzyme.

By varying the pNP substrate the ratio between lipase activity on unsaturated substrates having long fatty acyl chains (e.g. oleic acid) to short acyl chain (e.g. p-nitrophenyl butyrate and/or p-nitrophenyl valerate) can be determined. Variation of substrate may call for adjustment of e.g. buffer system, adjustments that are easily within the purview of the skilled person.

### Lipase Activity

### Enzymes are Diluted in Buffer

Substrate: The relevant pNP substrate (e.g. pNp-Valerate Sigma N-4377) 1 mM in Buffer prepared from stock-solution 100 mM in Methanol

Buffer: 50 mM TRIS, 0,4% Triton X-100, is prepared to pH 7,7

| Step | Preparation |
|---|---|
| 1 | Substrate-stock is made to 100 mM in Methanol |
| | 112 mg pNp-Valerate in 5 ml Methanol. |
| | This solution must be kept in a dark bottle or wrapped in |
| | aluminium foil to avoid daylight. |
| | The solution is to be kept at −18° C. |
| | Prepare fresh every 2 weeks |
| 2 | Enzymes are diluted to a concentration corresponding to Vmax < |
| | 70 mAbs/min |
| 3 | Substrate is prepared: |
| | 0.1 ml pNp-Valerate Stock-solution |
| | 9.9 ml Buffer |
| Step | Assay |
| 1 | Samples: Diluted enzyme 20 microL |
| | pNP-substrate 150 microL |
| 2 | Reference: Buffer 20 microL |
| | pNP-substrate 150 microL |
| | Reference must be included in every assay |
| 3 | The measurement is done as a kinetic measurement at 405 nm. |
| 4 | Setup: |
| | Wavelength: 405 nm |
| | Time: 10:00 min. |
| | Interval 10 sec. |
| | Reads: 61 |
| | Automix: Once |
| | Lag time: 0 |
| | End time: 10:00 |
| | ODmin .: 0 |
| | ODmax: 2 |
| 5 | Result: Vmax calculated from measurement points |

Results are calculated as:

[Vmax (enzyme)−Vmax(buffer)]/[slope of standard curve]

Microtiter plates (Thermo Scientific 269620 96F without lid microwell plate) for plate reader spectrophotometers (Molecular Devices Spectramax 190) can conveniently be used for determination of lipase activity by standard methods based on use of paranitrophenol-esters.
Terg-O-tometer (TOM) wash assay The Terg-O-tometer (TOM) is a medium scale model wash system that can be applied to test 16 different wash conditions simultaneously. A TOM is basically a large temperature-controlled water bath with up to 16 open metal beakers (1000 mL) submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker.
The TOM model wash system is mainly used in medium scale testing of detergents and enzymes at US or Latin America/Asian Pacific (LA/AP) wash conditions. In a TOM experiment, factors such as the ballast to soil ratio and the fabric to wash liquor ratio can be varied. Therefore, the TOM provides the link between small scale experiments, such as AMSA and mini-wash, and the more time-consuming full-scale experiments in top loader washing machines.

### Sequence Identity of the GCL I

The sequence identity between SEQ ID NO: 1, SEQ ID NO: 2, SEQ ID NO: 4, SEQ ID NO: 5 and SEQ ID NO: 6 has been calculated as defined in the paragraph “Sequence identity” with the following results:

TABLE 4
Sequence identity of GCL I

| | SEQ ID | SEQ ID | SEQ ID | SEQ ID | SEQ ID |
|---|---|---|---|---|---|
| | NO: 1 | NO: 2 | NO: 4 | NO: 5 | NO: 6 |
| SEQ ID NO: 1 | 100.00 | 99.63 | 99.08 | 99.26 | 98.35 |
| SEQ ID NO: 2 | 99.63 | 100.00 | 99.45 | 99.63 | 98.35 |
| SEQ ID NO: 4 | 99.08 | 99.45 | 100.00 | 99.82 | 97.79 |
| SEQ ID NO: 5 | 99.26 | 99.63 | 99.82 | 100.00 | 97.98 |
| SEQ ID NO: 6 | 98.35 | 98.35 | 97.79 | 97.98 | 100.00 |

### EXAMPLES

### Example 1: Terg-O-tometer (TOM) Wash

Water hardness was adjusted to the strength described below by addition of CaCl₂, MgCl₂ and NAHCO₃. Wash solutions were prepared with desired amount of detergent, temperature and water hardness in a bucket as described below. Detergent was dissolved during magnet stirring for 10 min. (Wash solution was used within 30 to 60 min after preparation).

Temperature and rotation (rpm) in the water bath in the Terg-O-Tometer were set according to the settings below. When temperature was adjusted according to settings (+1-1° C.) wash solution was added to TOM beaker according to the amount described below.

Agitation in the beaker was at 120 rpm. 2 homemade lard stains and 2 CS-10 butter fat stains from Equest were added to each of the beakers and wash carried out according to time stated below. 2 replicas of each stain type in each beaker. The swatches were rinsed in cold tap water for 10 minutes and dried in the dark overnight. Lard stains were weighted on an analytical scale (348-AV-50). CS-10 butter fat stains were cut out in 2 cm in diameter and used for odor measurements.

Textiles: Blue knitted cotton swatches (WFK80A, 5×5 cm, from Warwick Equest Ltd, Unit 55, Consett Business Park, Consett, County Durham, DH8 6BN, United Kingdom) were heated for 100° C. for 20 min, then left at room temperature for min 60 min. Lard (heated in water bath 75° C., 100 micro L) was applied on each swatch and heated at 100° C. for 20 min and then left at room 30 temperature for min 60 minutes. Weighted on analytical scale (348-AV-50). CS-10 (butter fat) stains was obtained from Center for Testmaterials BV, P.O. Box 120, 3133 KT Vlaardingen, the Netherlands.

TABLE 1.1
Experimental conditions

| | European (EU) conditions |
|---|---|
| Detergent | Ecover non-bio |
| Detergent dosage | 2.33 g/L and 0.47 g/L |
| Water hardness | 15° dH (Ca²⁺:Mg²⁺:HCO₃⁻ = 4:1:7.5) |
| Enzymes | SEQ ID NO: 1 and SEQ ID NO: 3 |
| Enzyme concentration | 0.1 or 5 mg total or active enzyme protein/L |
| in wash solution | |
| Test solution volume | 1000 mL |
| Wash time | 30 minutes |
| Rotation | 120 rpm |
| pH | as is |
| Temperature | 30° C. |

Results of the TOM wash is shown below in Table 1.2 (lipid removal) and Table 2.1 (odor).

TABLE 1.2
Lipid removal

| | 20% Ecover non-bio | | | 100% Ecover non-bio | | |
|---|---|---|---|---|---|---|
| | No | SEQ ID NO: 3 | SEQ ID NO: 1 | No | SEQ ID NO: 3 | SEQ ID NO: 1 |
| | enzyme | 0.1 ppm AEP | 5 ppm TEP | enzyme | 0.1 ppm AEP | 5 ppm TEP |
| Lipid | −4.96 | 8.87 | 30.1 | 17.4 | 24.9 | 24.1 |
| removal % | | | | | | |
| StdDev | 0.215 | 2.46 | 3.37 | 0.84 | 0.40 | 1.28 |

In fully formulated detergent, 100% Ecover non-bio, SEQ ID NO: 3 dosed at 0.1 ppm and SEQ ID NO: 1 dosed at 5 ppm results in similar lipid removal. Meanwhile, in reduced detergent the lipid removal is reduced significantly when SEQ ID NO: 3 is used, whereas SEQ ID NO: 1 increases the removal of lipid, confirming that GCL I can be used at reduced detergent level.

### Example 2: Odor Measurements

Odor Detection by Solid Phase Micro Extraction Gas Chromatograph measurements.
The butyric acid release (odor) from the lipase washed swatches was measured by Solid Phase Micro Extraction Gas Chromatography (SPME-GC) using the following method.
The cotton textile was washed as specified above and after wash, excess water was removed from the textile using filter paper and the textile was thereafter dried at 25° C. for 2 h. Each SPME-GC measurement was performed with four pieces of the washed and dried textile (5 mm in diameter), which were transferred to a Gas Chromatograph (GC) vial and the vial was closed. The samples were incubated at 30° C. for 24 hours and subsequently heated to 140° C. for 30 minutes and stored at 20° C.-25° C. for at least 4 hours before analysis. The analyses were performed on a Varian 3800 GC equipped with a Stabilwax-DA w/Integra-Guard column (30 m, 0.32 mm ID and 0.25 um df) and a Carboxen PDMS SPME fiber (85 micro-m). Sampling from each GC vial was done at 50° C. for 8 minutes with the SPME fiber in the head-space over the textile pieces and the sampled compounds were subsequently injected onto the column (injector temperature=250° C.). Column flow=2 ml helium/minute. Column oven temperature gradient: 0 minute=50° C., 2 minutes=50° C., 6 minutes 45 seconds=240° C., 11 minutes 45 seconds=240° C. Detection was done using a Flame Ionization Detector (FID) and the retention time for butyric acid was identified using an authentic standard.

TABLE 2.1
Odor generation (area under the curve)

| | 20% Ecover non-bio | | | 100% Ecover non-bio | | |
|---|---|---|---|---|---|---|
| | No | SEQ ID NO: 3 | SEQ ID NO: 1 | No | SEQ ID NO: 3 | SEQ ID NO: 1 |
| | enzyme | 0.1 ppm AEP | 5 ppm TEP | enzyme | 0.1 ppm AEP | 5 ppm TEP |
| Odor | 10138 | 750193 | 180824 | 3989 | 489409 | 150961 |
| generation | | | | | | |
| StdDev | 8004 | 60458 | 17988 | 1715 | 67053 | 2121 |

In fully formulated detergent, 100% Ecover non-bio, SEQ ID NO: 3 and SEQ ID NO: 1 result in similar lipid removal (see Table 1.2), but the odor generation is significant higher using SEQ ID NO: 3. Meanwhile, in reduced detergent level (20%), the odor generation is increased further for SEQ ID NO: 3 comparing to fully formulated detergent, whereas the odor generation only increases slightly for SEQ ID NO: 1 comparing fully formulated to reduced detergent (20%) and much less than SEQ ID NO: 3 in 20% detergent, confirming that GCL I can be used at reduced detergent level while maintaining good lipid removal (Example 1) and significantly reduced odor generation compared to the lipase having SEQ ID NO: 3.

### Example 3: Performance and Odor Generation in Model 1 Detergent with and without Rhamnolipid

0 or 14 wt % rhamnolipid (RL) was added to Model detergent 1, lipid removal and odor was evaluated as described in Example 1 and Example 2, except that the experimental conditions are as outlined in Table 3.1.

TABLE 3.1
Experimental conditions

| | European conditions |
|---|---|
| Detergent dosage | Model 1: 1.23 g/L |
| Lipase concentration in | 0.1 or 5 mg enzyme protein/L |
| wash solution | |
| Water hardness | 15° dH (Ca²⁺:Mg²⁺:HCO₃⁻ = 4:1:7.5) |
| Test solution volume | 1000 ml |
| Wash time | 50 minutes |
| Rotation | 120 rpm |
| pH | as is |
| Temperature | 30° C. |

Performance in terms of lipid removal is generally increased for GCL I when rhamnolipid is added to Model detergent 1 (Table 3.2).

TABLE 3.2
Lipid removal

| | Model 1 | | | | | | | | | | | |
|---|---|---|---|---|---|---|---|---|---|---|---|---|
| | No | | SEQ ID NO: 3 | | SEQ ID NO: 1 | | SEQ ID NO: 2 | | SEQ ID NO: 5 | | SEQ ID NO: 4 | |
| | enzyme | | 0.1 ppm AEP | | 5 ppm TEP | | 5 ppm TEP | | 5 ppm TEP | | 5 ppm TEP | |
| | No RL | With RL | No RL | With RL | No RL | With RL | No RL | With RL | No RL | With RL | No RL | With RL |
| Lipid | 7.8 | 9.4 | 40.4 | 67.8 | 54.2 | 89.9 | 45.6 | 41.2 | 66.2 | 94.3 | 71.4 | 94.2 |
| removal % | | | | | | | | | | | | |
| StdDev | 1.8 | 1.5 | 3.7 | 2.3 | 3.3 | 2.8 | 3.1 | 2.2 | 4.5 | 1.2 | 0.8 | 2.8 |

Performance increase in terms of reduced odor is generally seen for GCL I when rhamnolipid is added to Model detergent 1 (Table 3.3):

TABLE 3.3
Odor generation (area under the curve)

| | Model 1 | | | | | | | | | | | |
|---|---|---|---|---|---|---|---|---|---|---|---|---|
| | No | | SEQ ID NO: 3 | | SEQ ID NO: 1 | | SEQ ID NO: 2 | | SEQ ID NO: 5 | | SEQ ID NO: 4 | |
| | enzyme | | 0.1 ppm AEP | | 5 ppm TEP | | 5 ppm TEP | | 5 ppm TEP | | 5 ppm TEP | |
| | No RL | With RL | No RL | With RL | No RL | With RL | No RL | With RL | No RL | With RL | No RL | With RL |
| Odor | 8962 | 8338 | 1582304 | 1729217 | 85190 | 55177 | 98179 | 15711 | 324881 | 173317 | 469400 | 549869 |
| generation | | | | | | | | | | | | |
| StdDev | 10483 | 10000 | 77649 | 81933 | 23588 | 20611 | 25642 | 5163 | 38274 | 18819 | 125496 | 66443 |

### Example 4: Re-Deposition on Textile with and without Rhamnolipid

TABLE 4.1
Experimental conditions

| | European conditions |
|---|---|
| Detergent dosage | Model 2: 1.61 g/L |
| Lipase concentration in wash | 0.1 or 5 mg enzyme protein/L |
| solution | |
| Dosing of Medley Delicate | 67 mg/L |
| 300L* | |
| Water hardness | 15° dH (Ca²⁺:Mg²⁺:HCO₃⁻ = 4:1:7.5) |
| Test solution volume | 1000 ml |
| Wash time | 50 minutes |
| Rotation | 120 rpm |
| pH | as is |
| Temperature | 30° C. |

*Medley Delicate 300L is a commercial enzyme blend from Novozymes

The following data are conduted in the TOM wash setup as described ealier, but with the following changes: Commercial stains are used instead of lard stains. The Cooked beef fat stain (WESBBPC2) was washed together with Lard with carrot pigment (NZ-H002), Chicken fat with carrot pigment (NZ-009), Lamb fat with carrot pigment (NZ-H013), Butterfat with colorant (CS-10). Swatches (2 of each type) and enzymes including Medley Delicate 300 L (66,7 mg/L) were added as well as rhamnolipds (0 wt % or 7 wt %) to the beakers and washed for 50 minutes at 30° C. Swatches were rinsed in cold tap water for 5 minutes. The swatches were sorted and dried between filter paper in a drying cupboard without heat overnight. The textile around the stains (surrounding textile) and the stains were measured in remissions.

The wash performance was measured as the brightness of the color of the textile washed expressed in remission values (REM) or Intensity units. Remission measurements were made using a Macbeth 7000 Color Eye spectrophotometer. Each of the dry swatches was measured. As there is a risk of interference from the back-ground, the swatches were placed on top of 2 layers of fabric during the measurement of the remission. The remission was measured at 460 nm. The UV filter was not included. An average result for remission for the swatches was calculated.
The results depicted in Table 4.2 clearly shows that the addition rhamnolipid reduces redeposition of soil on the textile.

TABLE 4.2
Redeposition on surrounding textile with and without rhamnolipid

| | Model 2 | | | | | |
|---|---|---|---|---|---|---|
| | No | | SEQ ID NO: 3 | | SEQ ID NO: 1 | |
| | enzyme | | 0.1 ppm AEP | | 5 ppm TEP | |
| | No RL | With RL | No RL | With RL | No RL | With RL |
| Remission (460 nm) | 70.0 | 73.7 | 71.1 | 74.8 | 78.3 | 79.9 |
| Surrounding textile | | | | | | |
| StdDev | 1.8 | 1.2 | 0.6 | 1.4 | 0.3 | 0.8 |
| Surrounding textile | | | | | | |

The wash performance on the different stains is shown in Table 4.3 and it is observed that the performance of the GCL I (SEQ ID NO: 1) is better than the performance of the lipase having SEQ ID NO:3.

TABLE 4.3

| | Model detergent 2 | | | | | |
|---|---|---|---|---|---|---|
| | No | | SEQ ID NO: 3 | | SEQ ID NO: 1 | |
| | enzyme | | 0.1 ppm AEP | | 5 ppm TEP | |
| | No RL | With RL | No RL | With RL | No RL | With RL |
| Remission | 41.9 | 41.1 | 46.8 | 42.9 | 53.4 | 57.8 |
| (460 nm) | | | | | | |
| Cooked | | | | | | |
| beef fat | | | | | | |
| StdDev | 0.7 | 1.1 | 0.7 | 0.2 | 1.4 | 0.7 |
| Cooked | | | | | | |
| beef fat | | | | | | |
| Remission | 43.0 | 40.7 | 41.3 | 43.2 | 52.4 | 57.4 |
| (460 nm) | | | | | | |
| Lard/carrot | | | | | | |
| fat | | | | | | |
| StdDev | 0.6 | 0.8 | 1.8 | 1.3 | 0.5 | 0.2 |
| Lard/carrot | | | | | | |
| fat | | | | | | |
| Remission | 48.3 | 47.1 | 47.1 | 48.4 | 53.0 | 54.3 |
| (460 nm) | | | | | | |
| Chicken fat | | | | | | |
| StdDev | 0.4 | 0.8 | 0.3 | 0.7 | 0.6 | 0.6 |
| Chicken fat | | | | | | |
| Remission | 41.6 | 40.7 | 41.3 | 43.2 | 46.9 | 52.8 |
| (460 nm) | | | | | | |
| Lamb fat | | | | | | |
| StdDev | 0.6 | 1.5 | 1.0 | 1.1 | 1.0 | 0.5 |
| Lamb fat | | | | | | |
| Remission | 44.6 | 45.0 | 44.5 | 44.5 | 44.3 | 45.7 |
| (460 nm) | | | | | | |
| Butter fat | | | | | | |
| StdDev | 0.3 | 0.5 | 0.5 | 0.4 | 0.9 | 0.7 |
| Butter fat | | | | | | |

### Example 5: Fermentation and Purification of GCL I

For large-scale production of the lipase, and a recombinant strain of Aspergillus oryzae expressing the lipase under the control of an Aspergillus niger Neutral amylase!! promoter, as described in WO 04/032648, was cultured in 500m1 baffled flasks containing 150 ml of DAP-4C-1 medium (WO 12/103350). The cultures were shaken on a rotary table at 100 RPM at a temperature of 30° C. for 4 days. Culture broth was separated from cellular material by passage through a 0.22 um filtration unit.
Subsequently the culture supernatants were purified by gel filtration Sephadex G-25 and anion exchange Q-sepharose Fast Flow. Purification of culture supernatants was performed as follows: The culture broth is filtered through a Nalgene 0.2 pm filtration unit to remove the host cells. The filtrated supernatant is applied to a 1000mL Sephadex G-25 column (Cytiva) equilibrated in 50mM Hepes, pH 7.6. The enzyme was eluted from the column using 50 mM Hepes, pH 7.6, fractions are collected.
The pool of the fractions was applied to a 50 mL Q-sepharose Fast Flow column (Cytiva) equilibrated in 50 mM Hepes, pH 7.6. After washing the column with the equilibration buffer, the GCL-1 was eluted with a linear NaCl gradient (0-1M NaCl) using a 50 mM Hepes, 1M NaCl, pH 7.6 buffer over five column volumes. Fractions were analyzed by SDS-PAGE and fractions in which only one band is observed on the Coomassie stained SDS-PAGE gel are pooled as the purified enzyme preparation and used for further experiments.
GCL1 samples having SEQ ID NO:4 and SEQ ID NO:5 were purified with an additional step using Size exclusion as they had been kept cold (refrigerator). From earlier studies some aggregation of GCL 1 after cold storage has been observed, thus it was decided to use size exclusion to remove/avoid aggregation for GCL1 samples. The size exclusion was done by use of Sephadex G25 PD-10 column and the following gravity protocol:
PD-10 columns were equilibrated with 4 column volumes using 20 mM HEPES pH 7.0, 0.1 M NaCl buffer. The flow through were discarded.
2.5 mL GCL1 samples having SEQ ID NO:4 and SEQ ID NO:5 respectively were added pr. column and the sample entered the packed bed column completely, the flow-through was discarded.
Finally, the columns were eluted with 3.5 mL 20 mM HEPES pH 7.0, 0.1 M NaCl buffer and the eluate was collected.

1. A detergent composition comprising a Geotrichum candidum lipase I (GCL I) and at least one surfactant and optionally one or more enzymes.

2. The detergent composition according to claim 1, wherein the lipase has at least 70% identity to SEQ ID NO: 1, such as at least 80%, 85%, 90%, 91%, 92%, 93%, 94%, 95%, 96%, 97%, 98%, 99%, 99.1%, 99.2%, 99.3%, 99.4%, 99.5%, 99.6%, 99.7%,99.8%, or 99.9% identity to SEQ ID NO: 1.

3. The detergent composition according to claim 1, wherein the lipase has 100% identity to SEQ ID NO: 1, SEQ ID NO: 2 SEQ ID NO: 4, SEQ ID NO: 5 or SEQ ID NO: 6.

4. The detergent composition according to claim 2, wherein the lipase comprises 1 to 10 amino acid substitutions, preferably conservative amino acid substitutions, compared to SEQ ID NO: 1.

5. The detergent composition according to claim 1, comprising 1% to 15% wt % rhamnolipid.

6. A method for removal of lipid in a textile during a wash cycle comprising contacting the textile with a detergent composition comprising a Geotrichum candidum lipase I (GCL I) and at least one surfactant and optionally one or more enzymes.

7. The method according to claim 6, wherein the lipase has at least 70%, 80%, 85%, 90%, 91%, 92%, 93%, 94%, 95%, 96%, 97%, 98%, 99%, 99.1%, 99.2%, 99.3%, 99.4%, 99.5%, 99.6%, 99.7%,99.8%, or 99.9% identity to SEQ ID NO: 1.

8. The method according to claim 6, wherein the lipase has 100% identity to SEQ ID NO: 1, SEQ ID NO: 2 SEQ ID NO: 4 SEQ ID NO: 5 or SEQ ID NO: 6.

9. A method of washing a textile comprising:
a. exposing a textile to a wash liquor, said wash liquor comprising
i. Geotrichum candidum lipase I (GCL I), or
ii. a detergent composition according to claim 1;
b. completing at least one wash cycle, and
c. optionally rinsing the textile.

10. The washing method according to claim 9, wherein the temperature of the wash liquor is in the range of 5° C. to 90° C., or in the range of 10° C. to 80° C., or in the range of 10° C. to 70° C., or in the range of 10° C. to 60° C., or in the range of 10° C. to 50° C., or in the range of 15° C. to 40° C., or in the range of 20° C. to 30° C.

11. The washing method according to claim 9, wherein the odor from the wet and/or dry textile is lower compared to the odor generation from a lipase having SEQ ID NO: 3 when a substantially same level of lipid removal is obtained, wherein the odor generation is measured by a sensorial assay or butyric acid release as determined by Solid Phase Micro Extraction Gas Chromatograph measurements.

12. The washing method according to claim 11, wherein the odor generation is at least 2 times lower, such as 3 times lower, compared to the odor generation from a lipase having SEQ ID NO: 3 when a substantially same level of lipid removal is obtained by e.g. the Terg-O-tometer (TOM) wash assay, wherein the odor generation is measured by a sensorial assay or butyric acid release as determined by Solid Phase Micro Extraction Gas Chromatograph measurements.

13. The detergent composition, method and washing method according to claim 1, the composition further comprising one or more enzymes selected from the group consisting of proteases, amylases, deoxyribonucleases, xyloglucanases, pectinases, pectin lyases, xanthanases, peroxidases, haloperoxygenases, cellulases, licheninase, lipases, cutinases, catalases, oxidase, arabinose, galactanase and mannanases.

14. (canceled)

15. The method according to claim 9, wherein the wash liquor comprises from about 0.2 g detergent composition/L wash liquor to about 5 g detergent composition/L wash liquor.

16. A method of removing a lipid stain on a textile, the method comprising contacting a detergent composition of claim 1 with a textile comprising a lipid stain, and processing the textile in a wash liquor, wherein the wash liquor comprises from about 0.2 g detergent composition/L wash liquor to about 5 g detergent composition/L wash liquor.
